(19) United States
(12) Patent Application Publication
(10) Pub. No.: US 2025/0128535 A1
(43) Pub. Date: Apr. 24, 2025

(54) Decorative Film and Method for Producing Same, Ink-Receiving Film, and Decorative Film Kit

(71) Applicant: 3M INNOVATIVE PROPERTIES COMPANY, St. Paul, MN (US)

(72) Inventors: Hidetoshi Abe, Tendo City (JP); Koji Saito, Higashine-City (JP); Shinya Ohtomo, Higashine (JP)

(21) Appl. No.: 18/835,796

(22) PCT Filed: Feb. 24, 2023
(86) PCT No.: PCT/IB2023/051730

§ 371 Date: Aug. 5, 2024

(30) Foreign Application Priority Data
Feb. 24, 2022 (JP) 2022-027020

(51) Int. Cl. B41M 5/52; B41M 3/12; B41M 5/00; B41M 5/50; B41M 7/00; C09J 7/29; C09J 7/38

(52) U.S. Cl. CPC B41M 5/5281; B41M 3/12; B41M 5/0047; B41M 5/506; B41M 7/0027; C09J 7/29; C09J 7/385; B41M 2205/38; B41M 2205/40; C09J 2301/162; C09J 2301/302

(57) ABSTRACT

A decorative film of an embodiment includes a transparent surface layer including polycarbonate-based polyurethane, a transparent ink-receiving layer including polyether-based polyurethane, a printed layer disposed on the transparent ink-receiving layer, and a pressure-sensitive adhesive layer in this order.

### TECHNICAL FIELD

The present disclosure relates to a decorative film and a method for producing the same, an ink-receiving film, and a decorative film kit.

### BACKGROUND

There is known a decorative film to which decorativeness is imparted by performing inkjet printing on a film having an ink-receiving layer. Inkjet printing is known as one of on-demand technologies capable of supplying a product in response to a demand of a customer for a short delivery period.

Patent Document 1 (JP 6598343 B) describes “a graphic sheet including a partial printed layer, the graphic sheet comprising: a transparent resin surface layer, the partial printed layer on a back surface side of the transparent resin surface layer, an ink undercoat layer, and an adhesive layer in this order, wherein the transparent resin surface layer is a polycarbonate-based urethane resin, and the ink undercoat layer is an alkyd melamine-based resin”.

Patent Document 2 (JP 2014-46671 A) describes “a printed structure comprising a laminate in which an adhesive layer, a printed layer, and a substrate film are laminated in this order, wherein the printed layer is formed by printing using a solvent-based ink, the substrate film comprises a vinyl chloride-based resin composition containing a vinyl chloride-based resin having an average degree of polymerization from 600 to 1300 and a plasticizer, a content of the plasticizer being from 15 to 40 parts by weight with respect to 100 parts by weight of the vinyl chloride-based resin, the adhesive layer comprises an adhesive composition containing an acrylic adhesive having a weight average molecular weight from 600000 to 1000000, and the laminate has a thickness from 65 to 160 μm, and a total calorific value measured in a heat release test by a cone calorimeter tester using a plasterboard having a thickness of 12.5 mm as a base material of 8 MJ/mm² or less”.

Patent Document 3 (JP H9-509373 A) describes “a graphics overlay composite comprising a premask layer and a protective layer”.

Patent Document 4 (JP 2009-282471 A) describes “a graphics stricture comprising: a receptor layer; a printed layer prepared by printing on the receptor layer; and an acrylic white adhesive layer including an acrylic white adhesive, in this order, wherein the acrylic white adhesive contains a carboxyl group-containing (meth)acrylic polymer, from 8 to 150 parts by mass of a white pigment with respect to 100 parts by mass of the carboxyl group-containing (meth)acrylic polymer, and an amino group-containing (meth)acrylic polymer containing no aromatic vinyl monomer”.

### SUMMARY

In a case where inkjet printing is used to produce a decorative film, high-concentration printing having an ink concentration of more than 200% may be required to achieve opacity or color uniformity. However, when such high-concentration printing is performed on an ink-receiving layer of the decorative film, there is concern that a solvent or a low molecular weight component in the ink penetrates into an interior of the ink-receiving layer, and further reaches a layer adjacent to the ink-receiving layer, for example, a pressure-sensitive adhesive layer, to impair a function of the adjacent layer, for example, an adhesive force of the pressure-sensitive adhesive layer.

The present disclosure provides a decorative film in which an adhesive force of a pressure-sensitive adhesive layer does not decrease even when high-concentration printing is performed, and a method for producing the same.

The present inventors have found that it is possible to solve a problem of adhesive force decrease of a pressure-sensitive adhesive layer due to a solvent and a low molecular weight component in an ink by performing high-concentration printing on an ink-receiving layer of an ink-receiving film having a specific laminar structure to form a printed layer and laminating the pressure-sensitive adhesive layer on the printed layer.

According to an embodiment of the present disclosure, there is provided a decorative film including: a transparent surface layer including polycarbonate-based polyurethane; a transparent ink-receiving layer including polyether-based polyurethane; a printed layer disposed on the transparent ink-receiving layer; and a pressure-sensitive adhesive layer in this order.

According to another embodiment of the present disclosure, there is provided an ink-receiving film including: a support film; a transparent surface layer including polycarbonate-based polyurethane, and a transparent ink-receiving layer including polyether-based polyurethane in this order.

According to another embodiment of the present disclosure, there is provided a method for producing a decorative film, the method including: preparing an ink-receiving film including a support film, a transparent surface layer including polycarbonate-based polyurethane, and a transparent ink-receiving layer including polyether-based polyurethane in this order; preparing a pressure-sensitive adhesive film including a pressure-sensitive adhesive layer and a release liner; printing an ink on the transparent ink-receiving layer to form a printed layer; laminating the ink-receiving film and the pressure-sensitive adhesive film to bring the printed layer and the pressure-sensitive adhesive layer into contact with each other; and removing the support film to form a decorative film.

According to another embodiment of the present disclosure, there is provided a decorative film kit including: an ink-receiving film including a support film, a transparent surface layer including polycarbonate-based polyurethane, and a transparent ink-receiving layer including polyether-based polyurethane in this order; and a pressure-sensitive adhesive film including a pressure-sensitive adhesive layer and a release liner.

According to the present disclosure, it is possible to provide a decorative film in which an adhesive force of a pressure-sensitive adhesive layer does not decrease even when high-concentration printing is performed. The method for producing the decorative film, the ink-receiving film, and the decorative film kit of the present disclosure can be suitably used for on-demand production of decorative films including use of inkjet printing.

The above description should not be construed as disclosing all embodiments of the present invention and all advantages relating to the present invention.

### BRIEF DESCRIPTION OF DRAWINGS

FIG. 1 is a schematic cross-sectional view of a decorative film of one embodiment.

FIG. 2 is a schematic cross-sectional view of a decorative film of another embodiment.

FIG. 3 is an explanatory diagram of a method for producing a decorative film of one embodiment.

### DETAILED DESCRIPTION

Hereinafter, representative embodiments of the present invention will be described in more detail with reference to the drawing, as necessary, for the purpose of illustration, but the present invention is not limited to these embodiments.

In the present disclosure, the term “film” encompasses articles referred to as “sheets”.

In the present disclosure, the term “(meth)acrylic” refers to acrylic or methacrylic, and the term “(meth)acrylate” refers to acrylate or methacrylate.

In the present disclosure, “pressure-sensitive adhesion” refers to the characteristic of a material or composition that is permanently adhesive in the temperature range of usage, such as from 0° C. to 50° C., and that adheres to various surfaces with light pressure for a short time and does not exhibit a phase change (from liquid to solid).

In the present disclosure, the term “transparent” refers to an average transmittance of approximately 80% or greater, preferably approximately 85% or greater or approximately 90% or greater, in the visible light range (wavelengths from 400 nm to 700 nm), measured in accordance with JIS K 7375:2008. An upper limit of the average transmittance is not particularly limited, and can be, for example, approximately less than 100%, approximately less than or equal to 99%, or approximately less than or equal to 98%.

In the present disclosure, the term “translucent” refers to an average transmittance of approximately 40% or greater and less than approximately 80%, preferably approximately 75% or less, in the visible light range (wavelengths from 400 nm to 700 nm), measured in accordance with JIS K 7375:2008.

In the present disclosure, the term “opaque” means that a material or composition is neither transparent nor translucent.

In the present disclosure “non-PVC-based” means that a decorative film is substantially free of polyvinyl chloride, for example, a polyvinyl chloride film or a polyvinyl chloride layer. In an embodiment, a content of polyvinyl chloride of a decorative film is about 1 mass % or less, about 0.5 mass % or less, or about 0.1 mass % or less.

A decorative film of an embodiment includes a transparent surface layer including polycarbonate-based polyurethane, a transparent ink-receiving layer including polyether-based polyurethane, a printed layer disposed on the transparent ink-receiving layer, and a pressure-sensitive adhesive layer in this order.

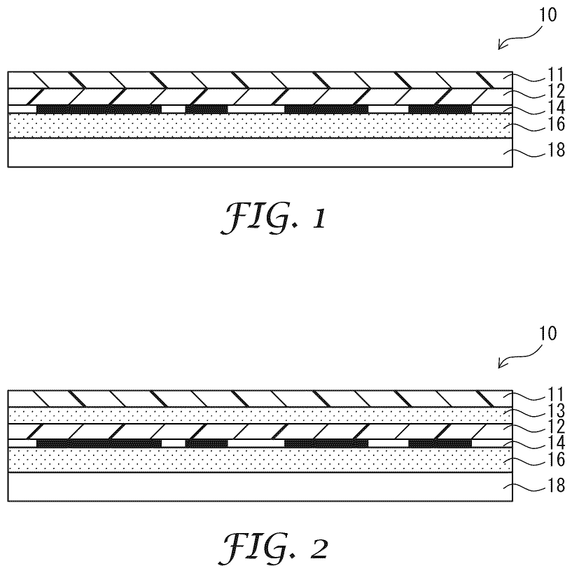

FIG. 1 illustrates a schematic cross-sectional view of a decorative film of an embodiment. A decorative film 10 includes a transparent surface layer 11, a transparent ink-receiving layer 12, a printed layer 14, and a pressure-sensitive adhesive layer 16 in this order. The decorative film 10 may further include a release liner 18 as an optional element.

The decorative film may further include a transparent pressure-sensitive adhesive layer between the transparent surface layer and the transparent ink-receiving layer. The transparent pressure-sensitive adhesive layer interposed between the transparent surface layer and the transparent ink-receiving layer can increase embossability of the decorative film. The decorative film of this embodiment can be suitably used as a graphic film for a license plate, for example.

A schematic cross-sectional view of a decorative film of another embodiment is illustrated in FIG. 2. A decorative film 10 includes a transparent surface layer 11, a transparent ink-receiving layer 12, a printed layer 14, and a pressure-sensitive adhesive layer 16 in this order, and further includes a transparent pressure-sensitive adhesive layer 13 between the transparent surface layer 11 and the transparent ink-receiving layer 12.

The transparent surface layer, the transparent ink-receiving layer, the printed layer, the pressure-sensitive adhesive layer, the liner, the transparent pressure-sensitive adhesive layer, and other elements constituting the decorative film will be described below in connection with a method for producing the decorative film.

In an embodiment, a decorative film is produced by: preparing an ink-receiving film including a support film, a transparent surface layer including polycarbonate-based polyurethane, and a transparent ink-receiving layer including polyether-based polyurethane in this order; preparing a pressure-sensitive adhesive film including a pressure-sensitive adhesive layer and a release liner; printing an ink on the transparent ink-receiving layer to form a printed layer; laminating the ink-receiving film and the pressure-sensitive adhesive film to bring the printed layer and the pressure-sensitive adhesive layer into contact with each other; and removing the support film to form the decorative film.

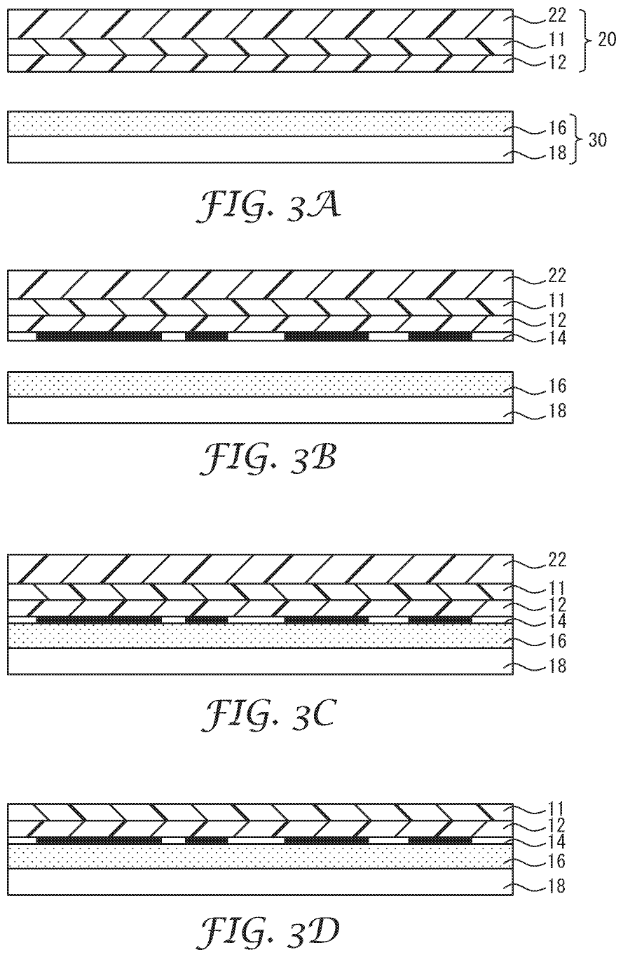

A method for producing a decorative film will be described below with reference to FIG. 3.

An ink-receiving film includes a support film, a transparent surface layer, and a transparent ink-receiving layer in this order. FIG. 3(a) illustrates an ink-receiving film 20 including a support film 22, a transparent surface layer 11, and a transparent ink-receiving layer 12 in this order.

The support film can increase handleability of the ink-receiving film and the decorative film, and can also protect the transparent surface layer during production, storage, transportation, or use of the decorative film. The support film is removed by the time the decorative film is used.

As the support film, for example, a resin film including a polyester such as polyethylene terephthalate, a polyolefin such as polyethylene or polypropylene, an acrylic polymer, a urethane-based polymer, or a fluorinated polymer can be used.

A thickness of the support film can be appropriately selected in accordance with a production condition and a use mode of the decorative film. A thickness of the support film may be, for example, about 5 μm or greater or about 10 μm or greater, but about 500 μm or less or about 300 μm or less.

The support film may be transparent, translucent, or opaque. In a case where an ink-receiving film having a transparent support film is used, ultraviolet irradiation can also be performed through the transparent surface layer and the transparent ink-receiving layer from the support film side, so that it is possible to cure an UV-curable ink printed on the transparent ink-receiving layer.

A surface (rear surface) of the support film opposite to the transparent surface layer may be subjected to surface treatment such as blocking-resistant treatment. The ink-receiving film or the decorative film having the support film subjected to the blocking-resistant treatment can be stacked as a sheet or wound into a roll shape to be stored.

The transparent surface layer includes polycarbonate-based polyurethane. The polycarbonate-based polyurethane is relatively hard and rigid, and thus it is possible to suppress damage to the surface of the decorative film and impart a strength and chemical resistance to the decorative film. In addition, the polycarbonate-based polyurethane has excellent weather resistance and water resistance, and thus it is possible to make the decorative film capable of withstanding use in an exterior wall of a building, an exterior of a vehicle, a kitchen, a lavatory, a bathroom, or the like.

The polycarbonate-based polyurethane has a structural unit derived from polycarbonate polyol and a structural unit derived from polyisocyanate. The polycarbonate-based polyurethane can be obtained by reaction between polycarbonate polyol and polyisocyanate using a known method.

The polycarbonate polyol is a compound that has a plurality of carbonate groups (—O—C(═O)—O—) in the main chain and has a plurality of hydroxy groups, and can be obtained by reaction between a polyol and a carbonate compound using a known method.

Examples of the polyol include: aliphatic diols such as ethylene glycol, 1,3-propanediol, 1,4-butanediol, 1,5-pentanediol, 3-methyl-1,5-pentanediol, 1,6-hexanediol, and neopentyl glycol; aliphatic triols such as glycerin; and alicyclic diols such as 1,4-cyclohexanedimethanol. The polyol can be used alone, or in combination of two or more types thereof.

Examples of the carbonate compound include dimethyl carbonate, ethylene carbonate, and diphenyl carbonate.

In an embodiment, the polycarbonate polyol is polycarbonate diol having a hydroxyl group at both ends of the carbonate main chain.

Examples of the polyisocyanate include: aliphatic diisocyanates such as hexamethylene diisocyanate, 2,2,4-trimethylhexamethylene diisocyanate, 2,4,4-trimethylhexamethylene diisocyanate, and lysine diisocyanate; alicyclic diisocyanates such as 4,4′-dicyclohexylmethane diisocyanate, isophorone diisocyanate, trans- and/or cis-1,4-cyclohexane diisocyanate, norbornene diisocyanate, and hydrogenated diphenylmethane diisocyanate; aromatic diisocyanates such as diphenylmethane diisocyanate and toluene diisocyanate; and biuret products, isocyanurate products, and adduct products of these. The polyisocyanate may be used alone or in combination of two or more types thereof. The polyisocyanate may be blocked isocyanate blocked by a blocking agent.

From the perspective of weather resistance of the decorative film, the polyisocyanate is preferably a non-yellowing aliphatic diisocyanate or an alicyclic diisocyanate, and more preferably an alicyclic diisocyanate capable of forming a transparent surface layer having a high strength.

The polycarbonate-based polyurethane may further include a structural unit derived from another polyol other than polycarbonate polyol. A content of the structural unit derived from the other polyol can be about 30 mass % or less, about 20 mass % or less, or about 10 mass % or less of the polycarbonate-based polyurethane. In an embodiment, the polycarbonate-based polyurethane does not include a structural unit derived from the other polyol.

Examples of the other polyol include: low molecular weight polyols having 2 to 20 carbon atoms such as ethylene glycol, 1,2-propane diol, 1,3-propane diol, 2-methyl-1,3-propane diol, 2-butyl-2-ethyl-1,3-propane diol, 1,4-butane diol, 1,6-hexane diol, and glycerin; (meth)acrylic polyols that are copolymers of hydroxyl-free (meth)acrylates such as methyl (meth)acrylate, n-butyl (meth)acrylate, 2-ethylhexyl (meth)acrylate, and ethylene glycol (meth)acrylic acid diester with hydroxyl group-containing (meth)acrylates such as 2-hydroxyethyl (meth)acrylate and ethylene glycol methacrylic acid monoester; polyester polyols such as polycaprolactone diol and polycaprolactone triol; and polyether polyols such as polyethylene glycol, polypropylene glycol, polytetramethylene glycol, propylene oxide adducts thereof, propylene oxide adducts of glycerin, propylene oxide adducts of saccharides such as sorbitol and sucrose, and propylene oxide adducts of compounds having active hydrogen such as ethylenediamine. The other polyol can be used alone, or in combination of two or more types thereof.

The transparent surface layer can be formed by applying a reactive polyurethane composition including polycarbonate polyol, polyisocyanate, and another optional polyol, or a polyurethane resin composition including polycarbonate-based polyurethane and an organic solvent or water onto the support film using, for example, knife coating, bar coating, blade coating, doctor coating, roll coating, cast coating, or the like, and heating or drying the composition as necessary. In the reactive polyurethane composition, the polycarbonate polyol, the polyisocyanate, and the optional other polyol react upon heating or drying to generate polycarbonate-based polyurethane in situ.

An equivalence ratio of the polyisocyanate to a total of the polycarbonate polyol and the other polyol in the polycarbonate-based polyurethane included in the reactive polyurethane composition or the polyurethane resin composition can be about 0.7 equivalents or greater, or about 0.9 equivalents or greater, but about 2 equivalents or less, or about 1.2 equivalents or less relative to 1 equivalent of the total of the polycarbonate polyol and the other polyol.

The reactive polyurethane composition may contain a catalyst. As the catalyst, a catalyst that is typically used in formation of a polyurethane resin, such as di-n-butyltin dilaurate, zinc naphthenate, zinc octenoate, or triethylenediamine, can be used. An amount of the catalyst used is typically about 0.005 parts by mass or greater, or about 0.01 parts by mass or greater, but about 0.5 parts by mass or less, or about 0.2 parts by mass or less, per 100 parts by mass of the reactive polyurethane composition.

The reactive polyurethane composition and the polyurethane resin composition may include, for example, an organic solvent for improving workability and coatability. Examples of the organic solvent include: ketones such as methyl ethyl ketone, methyl isobutyl ketone, and acetyl acetone; aromatic hydrocarbons such as toluene and xylene; alcohols such as ethanol and isopropyl alcohol; esters such as ethyl acetate and butyl acetate; and ethers such as tetrahydrofuran, propylene glycol monomethyl ether, propylene glycol monomethyl ether acetate, and dipropylene glycol monomethyl ether acetate. An amount of the organic solvent used is typically about 1 part by mass or more, or about 5 parts by mass or more, but about 90 parts by mass or less, or about 80 parts by mass or less, per 100 parts by mass of the composition. The polyurethane resin composition may be a water-based polyurethane resin composition containing water as a solvent. Water-based polycarbonate-based polyurethane included in the water-based polyurethane resin composition may include a chain extender such as a diamine compound as a structural unit, or may have an anionic group such as a carboxy group or a sulfonic acid group.

The polycarbonate-based polyurethane is preferably the water-based polycarbonate-based polyurethane. By using the water-based polycarbonate-based polyurethane, it is possible to reduce an amount of the organic solvent used in the production of the decorative film. The water-based polycarbonate-based polyurethane has a relatively low affinity for an organic solvent or a low molecular weight organic compound, and thus it is possible to further increase the chemical resistance of the transparent surface layer.

In an embodiment, the polycarbonate-based polyurethane has an alicyclic structure. As an example of the polycarbonate-based polyurethane having an alicyclic structure, there is exemplified a product obtained by further crosslinking, with a crosslinking agent, a linear polyurethane resin obtained by reacting a polyurethane prepolymer and a diamine chain extender, the polyurethane prepolymer being obtained by reacting polycarbonate diol having an alicyclic structure, an aliphatic diol including a carboxy group, and a polyisocyanate component including 4,4′-dicyclohexylmethane diisocyanate.

Examples of the polycarbonate diol having an alicyclic structure include polycarbonate diol synthesized from 1,4-cyclohexanedimethanol and 1,6-hexane diol.

Examples of the aliphatic diol including a carboxy group include 2,2-dimethylolpropionic acid, 2,2-dimethylolbutanoic acid, and 3,3-dimethylolpropionic acid.

An amount of 4,4′-dicyclohexylmethane diisocyanate included in the polyisocyanate component is not particularly limited, but can be, for example, about 30 mass % or greater, or about 50 mass % or greater of the polyisocyanate component.

The polyurethane prepolymer can be obtained by reacting the polycarbonate diol having an alicyclic structure, the aliphatic diol having a carboxy group, and the polyisocyanate component including 4,4′-dicyclohexylmethane diisocyanate using a known method.

The linear polyurethane resin can be obtained by reacting the polyurethane prepolymer with the diamine chain extender. Examples of the diamine chain extender include diamine compounds such as ethylenediamine, propylene diamine, and putrescine.

As the crosslinking agent, a known crosslinking agent that reacts with a carboxy group contained in the linear polyurethane resin can be used, and examples thereof include a polycarbodiimide compound, an aziridine compound, and an oxazoline compound.

A weight average molecular weight of the polycarbonate-based polyurethane is generally about 30,000 or more, about 50,000 or more, or about 80,000 or more, but about 300,000 or less, about 200,000 or less, or about 150,000 or less. In the present disclosure, the weight average molecular weight of the polyurethane is a molecular weight determined by gel permeation chromatography (GPC) using tetrahydrofuran (THF) or N-methylpyrrolidone (NMP) as the solvent, and using standard polystyrene (if the solvent is THF) or standard polymethyl methacrylate (if the solvent is NMP).

In an embodiment, the transparent surface layer includes about 50 mass % or more, about 60 mass % or more, or about 70 mass %, but 100 mass % or less, about 95 mass % or less, or about 90 mass % or less of the polycarbonate-based polyurethane. The resin component of the transparent surface layer is preferably composed of the polycarbonate-based polyurethane.

As another optional component, the transparent surface layer may contain an additive such as a UV absorbent, a photostabilizer, a thermal stabilizer, dispersant, a plasticizer, a flow enhancing agent, or a leveling agent. The thickness of the transparent surface layer is not particularly limited and, for example, can be about 5 μm or greater, about 10 μm or greater, or about 25 μm or greater, but about 500 μm or less, about 200 μm or less, or about 100 μm or less. By setting the thickness of the transparent surface layer to about 5 μm or more, it is possible to impart weather resistance and chemical resistance to the decorative film. By setting the thickness of the transparent surface layer to about 500 μm or less, it is possible to impart shape followability to the decorative film.

In an embodiment, a wetting tension of the transparent surface layer is about 30 mN/m or more, or about 35 mN/m or greater, but about 50 mN/m or less, or about 48 mN/m or less, when evaluated using a wetting tension reagent in accordance with JIS K 6768:1999.

The transparent ink-receiving layer includes a polyether-based polyurethane. The polyether-based polyurethane can impart ink-receptive capacity to the transparent ink-receiving layer.

The polyether-based polyurethane has a structural unit derived from polyalkylene glycol and a structural unit derived from polyisocyanate. The polyether-based polyurethane can be obtained by reacting polyalkylene glycol and polyisocyanate using a known method.

Examples of the polyalkylene glycol include polyethylene glycol, polypropylene glycol, polytetramethylene glycol, and polyhexamethylene glycol.

As the polyisocyanate, the polyisocyanate described for the polycarbonate-based polyurethane contained in the transparent surface layer can be used. From the perspective of weather resistance of the decorative film, the polyisocyanate is preferably a non-yellowing aliphatic diisocyanate or alicyclic diisocyanate, and more preferably an aliphatic diisocyanate capable of forming a transparent ink-receiving layer having excellent ink-receiving capability.

The polyether-based polyurethane may further include a structural unit derived from another polyol other than polyalkylene glycol. A content of the structural unit derived from the other polyol can be about 30 mass % or less, about 20 mass % or less, or about 10 mass % or less of the polyether-based polyurethane. In an embodiment, the polyether-based polyurethane does not include a structural unit derived from the other polyol.

Examples of the other polyol include: low molecular weight polyols having 2 to 20 carbon atoms such as ethylene glycol, 1,2-propane diol, 1,3-propane diol, 2-methyl-1,3-propane diol, 2-butyl-2-ethyl-1,3-propanediol, 1,4-butane diol, 1,6-hexane diol, and glycerin; (meth)acrylic polyols that are copolymers of hydroxyl-free (meth)acrylates such as methyl (meth)acrylate, n-butyl (meth)acrylate, 2-ethylhexyl (meth)acrylate, and ethylene glycol (meth)acrylic acid diester with hydroxyl group-containing (meth)acrylates such as 2-hydroxyethyl (meth)acrylate and ethylene glycol methacrylic acid monoester; polyester polyols such as polycaprolactone diol and polycaprolactone triol; and propylene oxide adducts of polyalkylene glycol such as polypropylene glycol and polytetramethylene glycol, propylene oxide adducts of glycerin, propylene oxide adducts of saccharides such as sorbitol and sucrose, and propylene oxide adducts of compounds having active hydrogen such as ethylenediamine. The other polyol can be used alone, or in combination of two or more types thereof.

The transparent ink-receiving layer can be produced by a method similar to that described for the transparent surface layer. Specifically, the transparent ink-receiving layer can be formed by applying a reactive polyurethane composition including polyalkylene glycol, polyisocyanate, and another optional polyol, or a polyurethane resin composition including a polyether-based polyurethane and an organic solvent or water onto the transparent surface layer using, for example, knife coating, bar coating, blade coating, doctor coating, roll coating, cast coating, or the like, and heating or drying the composition as necessary.

For an equivalence ratio of the polyisocyanate to the total of the polyalkylene glycol and the other polyol in the ether-based polyurethane contained in the reactive polyurethane composition, or the polyurethane resin composition, the polyisocyanate can be about 0.7 equivalents or greater, or about 0.9 equivalents or greater, but about 2 equivalents or less, or about 1.2 equivalents or less relative to 1 equivalent of the total of the polyalkylene glycol and the other polyol.

As a catalyst for the reactive polyurethane composition and an organic solvent for the reactive polyurethane composition and the polyurethane resin composition, those described for the transparent surface layer can be used.

The polyurethane resin composition may be a water-based polyurethane resin composition containing water as a solvent. The water-based polyether-based polyurethane included in the water-based polyurethane resin composition may include a chain extender such as a diamine compound as a structural unit, or may have an anionic group such as a carboxy group or a sulfonic acid group.

The polyether-based polyurethane is preferably a water-based polyether-based polyurethane. By using the water-based polyether-based polyurethane, it is possible to reduce an amount of the organic solvent used in the production of the decorative film. The affinity for a solvent-based ink of the transparent ink-receiving layer including the water-based polyether-based polyurethane is relatively low. Thus, in printing using a solvent-based ink, absorption of the solvent of the ink into the transparent ink-receiving layer is suppressed appropriately, and the pigment of the ink remains in a relatively large amount on the surface of the transparent ink-receiving layer. As a result, it is possible to increase a dot gain.

The polyether-based polyurethane may be crosslinked by a crosslinking agent. As the crosslinking agent, a known crosslinking agent that reacts with a carboxy group or the like can be used, and examples thereof include a polycarbodiimide compound, an aziridine compound, and an oxazoline compound.

The weight average molecular weight of the polyether-based polyurethane is generally about 30000 or greater, about 50000 or greater, or about 80000 or from, but about 300000 or less, about 200000 or less, or about 150000 or less.

In an embodiment, the transparent ink-receiving layer includes a polyether-based polyurethane of about 50 mass % or from, about 60 mass % or from, or about 70 mass %, but 100 mass % or less, about 95 mass % or less, or about 90 mass % or less.

The transparent ink-receiving layer may further include another resin such as polyester-based polyurethane or polyacrylate. The polyester-based polyurethane and the polyacrylate can impart blocking resistance to the transparent ink-receiving layer. Thus, the ink-receiving film can be stacked or wound into a roll shape while the transparent ink-receiving layer of the ink-receiving film is exposed.

In an embodiment, the transparent ink-receiving layer is free of polycarbonate-based polyurethane.

As another optional component, the transparent ink-receiving layer may include an additive such as a UV absorber, a photostabilizer, a thermal stabilizer, a dispersant, a plasticizer, a flow enhancing agent, or a leveling agent.

The thickness of the transparent ink-receiving layer is not particularly limited, but can be appropriately determined depending on the printing method and the ink used. The thickness of the transparent ink-receiving layer may be, for example, about 1 μm or greater, or about 5 μm or greater, but about 100 μm or less, or about 50 μm or less.

The total thickness of the transparent surface layer and the transparent ink-receiving layer can be about 10 μm or greater, or about 20 μm or greater, but about 80 μm or less, or about 60 μm or less. By setting the total thickness of the transparent surface layer and the transparent ink-receiving layer to the range described above, it is possible to lower an environmental load due to disposal after use without impairing non-flammability or flame retardancy of an adherend to which the decorative film is applied.

In an embodiment, the wetting tension of the transparent ink-receiving layer is about 45 mN/m or from, or about 50 mN/m or from, but about 73 mN/m or less, or about 65 mN/m or less when evaluated using a wetting tension reagent in accordance with JIS K 6768:1999.

The transparent ink-receiving layer may have a primer layer to enhance printability, and may be subjected to surface treatment such as plasma treatment, corona treatment, flame treatment, electron beam irradiation treatment, or crude surface treatment, ozone treatment.

The ink-receiving film may further include a transparent pressure-sensitive adhesive layer between the transparent surface layer and the transparent ink-receiving layer. The transparent pressure-sensitive adhesive layer can enhance the embossability of the decorative film.

A generally used acrylic, polyolefin-based, polyurethane-based, polyester-based, or rubber-based pressure-sensitive adhesive can be used to form the transparent pressure-sensitive adhesive layer on the transparent surface layer. Thereafter, the transparent ink-receiving layer is formed directly on the transparent pressure-sensitive adhesive layer, or is separately formed on a liner and then transferred and laminated onto the transparent pressure-sensitive adhesive layer.

The thickness of the transparent pressure-sensitive adhesive layer can be about 10 μm or greater, or about 20 μm or greater, but about 50 μm or less, or about 40 μm or less.

The pressure-sensitive adhesive film includes a pressure-sensitive adhesive layer and a release liner. FIG. 3(a) illustrates a pressure-sensitive adhesive film 30 including a pressure-sensitive adhesive layer 16 and a release liner 18.

The pressure-sensitive adhesive layer can be formed on the release liner using a generally used acrylic, polyolefin-based, polyurethane-based, polyester-based, or rubber-based pressure-sensitive adhesive. The pressure-sensitive adhesive included in the pressure-sensitive adhesive layer may be crosslinked with a crosslinking agent.

The pressure-sensitive adhesive layer is preferably an acrylic pressure-sensitive adhesive layer including an acrylic pressure-sensitive adhesive. The acrylic pressure-sensitive adhesive layer has excellent durability, weather resistance, and adhesive force. The acrylic pressure-sensitive adhesive may be crosslinked with a crosslinking agent such as a bisamide crosslinking agent, an aziridine crosslinking agent, a carbodiimide crosslinking agent, an epoxy crosslinking agent, or an isocyanate crosslinking agent.

In an embodiment, the pressure-sensitive adhesive layer includes a white colorant. By making the pressure-sensitive adhesive layer white, it is possible to conceal a color of an underlying layer to which the decorative film is applied. Examples of the white colorant include white pigments such as titanium oxide, zinc carbonate, zinc oxide, and zinc sulfide.

The acrylic pressure-sensitive adhesive layer may include a carboxy group-containing (meth)acrylic polymer, an amino group-containing (meth)acrylic polymer, and a white colorant such as titanium oxide. The carboxy group-containing (meth)acrylic polymer and the amino group-containing (meth)acrylic polymer can cause a higher amount of the white colorant to be stably dispersed in the pressure-sensitive adhesive layer to increase the concealability of the pressure-sensitive adhesive layer, and at the same time, can suppress reduction in cohesion force of the pressure-sensitive adhesive layer due to dispersion of the white colorant to maintain the adhesion property. The adhesive property is maintained in this manner, and thus the printed layer and the pressure-sensitive adhesive layer can be more firmly bonded to each other when laminating the ink-receiving film and the pressure-sensitive adhesive film. The carboxy group-containing (meth)acrylic polymer and/or the amino group-containing (meth)acrylic polymer may be crosslinked with the above-described crosslinking agent.

The thickness of the pressure-sensitive adhesive layer can be about 10 μm or greater, about 20 μm or greater, or about 30 μm or greater, but about 200 μm or less, about 120 μm or less, or about 80 μm or less.

Examples of the release liner include: paper having a surface subjected to releasing treatment using a silicone releasing agent or the like; a film including a plastic material such as polyethylene, polypropylene, polyester, or cellulose acetate; and laminate paper coated with such a plastic material.

The thickness of the release liner can be about 5 μm or greater, about 15 μm or greater, or about 25 μm or greater, but about 300 μm or less, about 200 μm or less, or about 150 μm or less.

The printed layer is formed by printing an ink on the transparent ink-receiving layer of the ink-receiving film. The ink is printed on the transparent ink-receiving layer to form the printed layer separated from the pressure-sensitive adhesive layer. This can prevent reduction in adhesive force of the pressure-sensitive adhesive layer due to the solvent and the low molecular weight component contained in the ink. Although the solvent and the low molecular weight component contained in the ink may come into contact with or penetrate into the transparent surface layer through the transparent ink-receiving layer, it is possible to maintain the surface quality and strength thereof in a practical range because the transparent surface layer has high chemical resistance as described above.

FIG. 3(b) illustrates the printed layer 14 formed on the ink-receiving layer 12 of the ink-receiving film 20.

Examples of the printing method include gravure direct printing, gravure offset printing, inkjet printing, laser printing, and screen printing.

The ink layer is preferably an inkjet printed layer formed by inkjet printing, because it is suitable for on-demand production. The inkjet printing may be, for example, high-concentration printing having an ink concentration of 200% or more.

Examples of the ink include a solvent-based ink, a solventless ink, an aqueous ink, and a UV curable ink. In an embodiment, the ink is a solvent-based ink excellent in printing property. In another embodiment, the ink is a UV curable ink. The UV curable ink has characteristics suitable for inkjet printing, and it is possible to reduce an effect of heat on the ink-receiving film.

The thickness of the printed layer is not particularly limited and, for example, can be approximately 1 μm or greater, or approximately 2 μm or greater, and approximately 20 μm or less, or approximately 10 μm or less.

The ink-receiving film and the pressure-sensitive adhesive film are layered so that the printed layer and the pressure-sensitive adhesive layer are in contact with each other. The layering can be carried out by heating and/or pressurizing as needed.

FIG. 3(c) illustrates a state in which the ink-receiving film and the pressure-sensitive adhesive film are layered in such a manner that the printed layer 14 and the pressure-sensitive adhesive layer 16 are in contact with each other.

The support film is removed from a laminate obtained by the layering to form the decorative film. The support film may cover the transparent surface layer immediately before the decorative film is used.

FIG. 3(d) illustrates the decorative film with the support film 22 removed.

The thickness of the decorative film can be about 10 μm or greater, or about 20 μm or greater, but about 1 mm or less, or about 500 μm or less. The thickness of the decorative film does not include the thickness of the support film and the thickness of the release liner.

In an embodiment, the decorative film includes the transparent surface layer, the transparent ink-receiving layer, the printed layer, and the pressure-sensitive adhesive layer, and has a thickness of about 50 μm or greater, and about 150 μm or less. A thin decorative film having such a simple laminate structure has low combustion heat, and has a low amount of the organic material used. Thus, it is possible to lower the environmental load due to disposal after use without impairing non-flammability or flame retardancy of an adherend to which the decorative film is applied.

In an embodiment, the decorative film has a non-PVC-based decorative film.

The decorative film may be transparent, translucent, or opaque. A transparent or translucent decorative film can be used for an internally illuminated signage.

In an embodiment, a tensile strength at 2% strain of the decorative film is about 4 N/25 mm or greater, about 5 N/25 mm or greater, or about 6 N/25 mm or greater, but about 40 N/25 mm or less, about 30 N/25 mm or less, or about 20 N/25 mm or less. The tensile strength at 2% strain of the decorative film is determined by a method described in the examples.

In an embodiment, the yield strength of the decorative film is about 6 N/25 mm or greater, about 9 N/25 mm or greater, or about 12 N/25 mm or greater, but about 90 N/25 mm or less, about 60 N/25 mm or less, or about 30 N/25 mm or less. The yield strength of the decorative film is determined by a method described in the examples.

In an embodiment, the decorative film has an elongation of about 30% or from, about 40% or from, or about 50% or from, but about 500% or less, about 400% or less, or about 300% or less. The elongation of the decorative film is determined by a method described in the examples.

In an embodiment, the adhesive force of the decorative film is about 4 N/25 mm or from, about 6 N/25 mm or from, or about 8 N/25 mm or from, but about 50 N/25 mm or less, about 40 N/25 mm or less, or about 30 N/25 mm or less, when 180 degree peeling is performed at a temperature of 20° C. and a peeling rate of 300 mm/min. The adhesive force of the decorative film is determined by a method described in the examples.

The decorative film of the present disclosure has excellent low-temperature impact resistance because the transparent surface layer and the transparent ink-receiving layer constituting the decorative film are based on polyurethane. The decorative film of an embodiment can pass a Gardner impact resistance test at a temperature of −20° C. The decorative film of this embodiment can be suitably used as a graphics film for a license plate.

The decorative film of the present disclosure can be used in a vehicle and components thereof used indoor/outdoor, a building (inner/outer wall, pillar, and the like), a traffic sign, a packaging material, a signage, an internally illuminated signage, and the like.

In an embodiment, the decorative film is provided in a form of a decorative film kit in which the above-described ink-receiving film and pressure-sensitive adhesive film are combined. A user can use the decorative film kit to form a printed layer by on-demand printing, and produce a decorative film in situ.

### EXAMPLES

In the following examples, specific embodiments of the present disclosure will be illustrated, but the present invention is not limited to these examples. All ‘part’ and ‘percent’ are based on mass unless otherwise specified. A numerical value essentially includes an error originated from a measurement principle and a measuring device. The numerical value is generally indicated by a significant digit that is rounded.

The raw materials and reagents used in producing the decorative film are shown in Table 1.

TABLE 1

| | | | | | Solid | |
|---|---|---|---|---|---|---|
| | | Tg | | | content | |
| | Composition or description¹⁾ | (° C.) | Mw | Solvent | (mass %) | Supplier |
| Polyurethane | NeoRezR (trade name) R650, | — | — | Water | 38 | DSM Coating Resins |
| 1 (PU1) | polyether polyurethane, non- | | | | | (Zwolle, Netherlands) |
| | yellowing | | | | | |
| Polyurethane | NeoRezR (trade name) R2005, | — | — | Water | 35 | DSM Coating Resins |
| 2 (PU2) | blend of polyester polyurethane | | | | | (Zwolle, Netherlands) |
| | and polyacrylate polymer, non- | | | | | |
| | yellowing | | | | | |
| Polyurethane | ETERNACOLL UW5002, water- | — | — | Water | 30 | Ube Industries, Ltd. |
| 3 (PU3) | based polycarbonate polyurethane, | | | | | (Minato-ku, Tokyo, |
| | elastic modulus about 1200 MPa | | | | | Japan) |
| Polyurethane | ETERNACOLL UW3039E, water- | — | — | Water | 30 | Ube Industries, Ltd. |
| 4 (PU4) | based polycarbonate polyurethane, | | | | | (Minato-ku, Tokyo, |
| | elastic modulus about 520 MPa | | | | | Japan) |
| Polyurethane | NeoRezR (trade name) R989, blend | — | — | Water | 40 | DSM Coating Resins |
| 5 (PU5) | of polyester polyurethane and | | | | | (Zwolle, Netherlands) |
| | polyacrylate polymer, non- | | | | | |
| | yellowing | | | | | |
| Dispersant 1 | MMA-BMA-DMAEMA = 60:34:6 | 63 | 68000 | EtOAc | 40 | — |
| (D1) | | | | | | |
| Tacky | BA-2EHA-AN-AA = 58:36:2:4 | −53 | 500000 | EtOAc | 33 | — |
| adhesive | | | | | | |
| (ADH1) | | | | | | |
| polymer 1 | | | | | | |
| (ADH1) | | | | | | |
| Tacky | 2EHA-BA-AA = 62:32:6 | −57 | 280000 | EtOAc | 60 | — |
| adhesive | | | | | | |
| polymer 2 | | | | | | |
| (ADH2) | | | | | | |
| Tacky | BA-AA = 96:4 | −50 | 580000 | EtOAc/ | 42 | — |
| adhesive | | | | toluene | | |
| polymer 3 | | | | | | |
| (ADH3) | | | | | | |
| Tacky | BA-AA = 90:10 | −44 | 630000 | EtOAc/ | 33 | — |
| adhesive | | | | toluene | | |
| polymer 4 | | | | | | |
| (ADH4) | | | | | | |
| Crosslinking | Bisamide-based, (1,1′-isophthaloyl- | — | — | Toluene | 5 | 3M Japan Limited |
| agent 1 | bis(2-methyl aziridine) | | | | | (Shinagawa-ku, |
| (CL1) | | | | | | Tokyo, Japan) |
| Crosslinking | Tetrad-X, polyfunctional liquid | — | — | — | 100 | Mitsubishi Gas |
| agent 2 | epoxy resin, N,N,N′,N′- | | | | | Chemical Company, |
| (CL2) | tetraglycidyl-m-xylenediamine | | | | | Inc. |
| | | | | | | (Chiyoda-ku, Tokyo, |
| | | | | | | Japan) |
| Crosslinking | Carbozilite (trade name) V-02, | — | — | Water | 40 | Nisshinbo Chemical |
| agent 3 | polycarbodiimide, NCN equivalent | | | | | Inc. |
| (CL3) | weight 590 | | | | | (Chuo-ku, Tokyo, |
| | | | | | | Japan) |
| Crosslinking | E-AX, polyfunctional liquid epoxy | — | — | Toluene | 5 | Soken Chemical & |
| agent 4 | resin, N,N,N′, N′-tetraglycidyl-m- | | | | | Engineering Co., Ltd. |
| (CL4) | xylenediamine | | | | | (Toshima-ku, Tokyo, |
| | | | | | | Japan) |
| White | ADH1-based white pressure- | — | — | — | — | — |
| pressure- | sensitive adhesive | | | | | |
| sensitive | | | | | | |
| adhesive 1 | | | | | | |
| (WA1) | | | | | | |
| White | ADH2-based white pressure- | — | — | — | — | — |
| pressure- | sensitive adhesive | | | | | |
| sensitive | | | | | | |
| adhesive 2 | | | | | | |
| (WA2) | | | | | | |
| White | ADH3-based white pressure- | — | — | — | — | — |
| pressure- | sensitive adhesive | | | | | |
| sensitive | | | | | | |
| adhesive 3 | | | | | | |
| (WA3) | | | | | | |

¹⁾BA: n-butyl acrylate;
AN: acrylonitrile,
AA: acrylic acid,
2EHA: 2-ethylhexyl acrylate;
EtOAc: ethyl acetate

### Example 1

A mixer (TK Auto Homo Mixer, PRIMIX Corporation (Awaji-shi, Hyogo, Japan)) was used to mix polyurethane 1 (PU1) and polyurethane 2 (PU2), thereby preparing a transparent ink-receiving layer composition. The mass ratio of PU1 and PU2 was 100:10 in terms of solid content. The solid content of the transparent ink-receiving layer composition was about 30 mass %.

Polyurethane 3 (PU3) was applied onto a polyester film (support film) having a thickness of 50 μm using a knife coater, and dried at 95° C. for 5 minutes to form a transparent surface layer having a thickness of 18 μm. The transparent ink-receiving layer composition was applied onto the transparent surface layer using a knife coater, and dried at 95° C. for 5 minutes to form a transparent ink-receiving layer having a thickness of 20 μm. In this way, an ink-receiving film having the support film/transparent surface layer/transparent ink-receiving layer laminated in this order was produced.

A premix including white pigment 1 (WP1, Ti-Pure (trade name) R960, The Chemours Company (Wilmington, Delaware, USA)), dispersant 1 (D1), and methyl ethyl ketone (MEK) was prepared. The mass ratio of WP1 and D1 was 5:1 in terms of solid content. The solid content of the premix was about 66 mass %.

The premix and tacky adhesive polymer 1 (ADH1) were mixed. The mass ratio of ADH1, white pigment 1, and D1 was 100:50:10 in terms of solid content. Crosslinking agent 1 (CL1) is mixed to the obtained mixture to prepare a white pressure-sensitive adhesive 1 (WA1). The mass ratio of ADH1 and CL1 was 100:0.2 in terms of solid content. The solid content of WA1 was about 35 mass %.

WA1 was applied onto a silicone-coated polyethylene laminate paper liner using a knife coater, and dried at 95° C. for 5 minutes to form a white pressure-sensitive adhesive layer having a thickness of 65 μm. In this manner, a pressure-sensitive adhesive film including the white pressure-sensitive adhesive layer and the release liner was produced.

A printed layer was formed on the transparent ink-receiving layer of the ink-receiving film by inkjet printing using a JV5 printer and an ES3 ink (MIMAKI ENGINEERING CO., LTD. (Toumi-shi, Nagano, Japan)). The ink concentration was C66, M67, and Y67. The white pressure-sensitive adhesive layer was laminated on the printed layer, and the support film was removed to produce a decorative film of Example 1.

### Example 2

A decorative film of Example 2 was produced in the same procedure as in Example 1 except that PU3 was changed to polyurethane 4 (PU4), the thickness of the transparent surface layer was changed to 30 μm, and the thickness of the transparent ink-receiving layer was changed to 20 μm.

### Example 3

White pressure-sensitive adhesive 3 (WA3) was prepared in the same procedure as in Example 1 except that ADH1 was changed to tacky adhesive polymer 3 (ADH3), and CL1 was changed to crosslinking agent 2 (CL2). The mass ratio of ADH3, WP1, and D1 was 100:40:8 in terms of solid content. The mass ratio of ADH3 and CL2 was 100:0.05 in terms of solid content. The solid content of WA3 was about 38 mass %.

WA3 was applied onto a silicone-coated polyethylene laminate paper liner using a knife coater, and dried at 95° C. for 5 minutes to form a white pressure-sensitive adhesive layer having a thickness of 40 μm. In this manner, a pressure-sensitive adhesive film including the white pressure-sensitive adhesive layer and the release liner was produced. A decorative film of Example 3 was produced by the same procedure as in Example 1 except that this pressure-sensitive adhesive film was used.

### Example 4

A decorative film of Example 4 was produced in the same procedure as in Example 2 except that the pressure-sensitive adhesive film used in Example 3 was used.

### Example 5

A decorative film of Example 5 was produced using the transparent surface layer and the transparent ink-receiving layer as described in Table 2.

### Example 6

A white pressure-sensitive adhesive 2 (WA2) was prepared in the same procedure as in Example 1 except that ADH1 was changed to tacky adhesive polymer 2 (ADH2), and CL1 was changed to CL2. The mass ratio of ADH2, WP1, and D1 was 100:50:10 in terms of solid content. The mass ratio of ADH2 and CL2 was 100:0.23 in terms of solid content. The solid content of WA2 was about 58 mass %.

WA2 was applied onto a silicone-coated polyethylene laminate paper liner using a knife coater, and dried at 95° C. for 5 minutes to form a white pressure-sensitive adhesive layer having a thickness of 30 μm. In this manner, a pressure-sensitive adhesive film including the white pressure-sensitive adhesive layer and the release liner was produced. A decorative film of Example 6 was produced by the same procedure as in Example 2 except that this pressure-sensitive adhesive film was used.

### Example 7 to Example 9

Decorative films of Example 7 to Example 9 were produced using the transparent surface layers and the transparent ink-receiving layers as described in Table 2, respectively.

### Example 10

Crosslinking agent 3 (CL3) was mixed to the transparent ink-receiving layer composition of Example 1 to prepare a transparent ink-receiving layer composition. A content of CL3 was 3 parts by mass based on 100 parts by mass of the total of PU1 and PU2. A decorative film of Example 10 was produced in the same procedure as in Example 1 except that this transparent ink-receiving layer composition was used, and a thickness of the transparent ink-receiving layer was changed to 9 μm.

### Example 11 to Example 13

Decorative films of Example 11 to Example 13 were produced using the transparent surface layers and the transparent ink-receiving layers as described in Table 2, respectively.

### Example 14

A decorative film of Example 14 was produced using the transparent surface layer and the transparent ink-receiving layer as described in Table 2.

### Reference Example 1 to Reference Example 13

Laminate films of Reference Example 1 to Reference Example 13 were produced in the same procedure as in Example 1 to Example 13 except that no printed layer was provided. Reference Example 1 to Reference Example 13 have the same layer configurations as those of Example 1 to Example 13, respectively, except that there is no printed layer, and were prepared for the purpose of examining an effect on characteristics of the decorative film such as a tensile strength at 2% strain or a yield strength by presence or absence of the printed layer.

### Reference Example 14

PU3 was applied onto a polyester film (support film) having a thickness of 50 μm using a knife coater, and dried at 95° C. for 5 minutes to form a transparent surface layer having a thickness of 18 μm. The support film was peeled off to produce a film of Reference Example 14.

### Reference Example 15

Polyurethane 4 (PU4) was applied onto a polyester film (support film) having a thickness of 50 μm using a knife coater, and dried at 95° C. for 5 minutes to form a transparent surface layer having a thickness of 30 μm. The support film was peeled off to produce a film of Reference Example 15.

### Reference Example 16

The transparent ink-receiving layer composition of Example 1 was applied onto the film of Reference Example 15 using a knife coater, and dried at 95° C. for 5 minutes to form a transparent ink-receiving layer having a thickness of 10 μm. The support film was peeled off to produce a laminate film of Reference Example 16.

### Comparative Example 1

The transparent ink-receiving layer composition (mixture of PU1 and PU2) of Example 1 was applied onto a polyester film (support film) having a thickness of 50 μm using a knife coater, and dried at 95° C. for 5 minutes to form a transparent surface layer having a thickness of 18 μm. PU3 was applied onto the transparent surface layer using a knife coater, and dried at 95° C. for 5 minutes to form a transparent ink-receiving layer having a thickness of 20 μm. In this way, an ink-receiving film having the support film/transparent surface layer/transparent ink-receiving layer laminated in this order was produced. A decorative film of Comparative Example 1 was produced by the same procedure as in Example 1 except that this ink-receiving film was used.

### Comparative Example 2

An acrylic film (transparent surface layer and transparent ink-receiving layer) having a thickness of 30 μm and a polyester film (support film) having a thickness of 50 μm were laminated to produce an ink-receiving film. A decorative film of Comparative Example 2 was produced by the same procedure as in Example 1 except that this ink-receiving film was used.

### Comparative Example 3

The transparent ink-receiving layer composition (mixture of PU1 and PU2) of Example 1 was applied onto a polyester film (support film) having a thickness of 50 μm using a knife coater, and dried at 95° C. for 5 minutes to form a transparent surface layer (also serving as a transparent ink-receiving layer) having a thickness of 30 μm. In this manner, an ink-receiving film including the support film and the transparent surface layer (also serving as the transparent ink-receiving layer) was produced. A decorative film of Comparative Example 3 was produced by the same procedure as in Example 1 except that this ink-receiving film was used.

### Tensile Strength at 2% Strain

A test piece was prepared by cutting a film into a width of 25 mm and a length of 150 mm. Using a tensile tester (Tensilon universal testing machine, model: RTC-1210A, manufactured by A&D Company, Limited (Toshima-ku, Tokyo, Japan)), the tensile strength at 2% strain at 20° C. was measured under the condition at 20° C., the distance between grips of 100 mm, at the tensile speed of 300 mm/min.

### Yield Strength

A test piece was prepared by cutting a film into a width of 25 mm and a length of 150 mm. Using a tensile tester (Tensilon universal testing machine, model: RTC-1210A, manufactured by A&D Company, Limited (Toshima-ku, Tokyo, Japan)), the tensile strength at the yield point at 20° C. was measured under the condition at 20° C., the distance between grips of 100 mm, at the tensile speed of 300 mm/min.

### Elongation

A test piece was prepared by cutting a film into a width of 25 mm and a length of 150 mm. Using a tensile tester (Tensilon universal testing machine, model: RTC-1210A, manufactured by A&D Company, Limited (Toshima-ku, Tokyo, Japan)), the elongation at 20° C. was measured under the condition at 20° C., the distance between grips of 100 mm, at the tensile speed of 300 mm/min. The elongation is defined by the following equation.

Elongation (%)=(length of test piece after test-length of test piece before test)/length of test piece before test

### Adhesive Force 1

A test piece was prepared by cutting a film into a width of 25 mm and a length of 150 mm. The test piece was adhered on a melamine-coated panel (Paltek Corporation (Hiratsuka-shi, Kanagawa, Japan)) at 23° C. using a roller. The adhering method was in accordance with JIS Z 0237:2009. The test piece was left at 20° C. for 48 hours. Using a tensile tester (Tensilon universal testing machine, model: RTC-1210A, manufactured by A&D Company, Limited (Toshima-ku, Tokyo, Japan)), the adhesive force at the time of performing 180 degree peeling was measured at a peeling rate of 300 mm/min at 20° C.

### Weather Resistance 1

A test piece was prepared by cutting a film into a square with 65 mm side. The test piece was adhered to an aluminum panel having a thickness of 1 mm at room temperature by using a squeegee. By using a xenon weatherometer Ci5000 Weather-Ometer (Toyo Seiki Seisaku-sho, Ltd., (Kita-ku, Tokyo, Japan)), the test piece was exposed to xenon light for 500 hours. The test conditions were in accordance with JIS K 5600-7-7:2008. The case where discoloring was not observed in the test piece was evaluated as A. The case where discoloring was observed in the test piece was evaluated as B. The case where the test piece was peeled off from the aluminum panel was evaluated as C.

### Weather Resistance 2

A test piece was prepared by cutting a film into a square with 65 mm side. The test piece was adhered to an aluminum panel having a thickness of 1 mm at room temperature by using a squeegee. By using a xenon weatherometer Ci5000 Weather-Ometer (Toyo Seiki Seisaku-sho, Ltd., (Kita-ku, Tokyo, Japan)), the test piece was exposed to xenon light for 2500 hours. The test conditions were in accordance with JIS K 5600-7-7:2008. The case where discoloring was not observed in the test piece was evaluated as A. The case where discoloring was observed in the test piece was evaluated as B. The case where the test piece was peeled off from the aluminum panel was evaluated as C.

### Inkjet Printing Property

Inkjet printing was performed on the transparent ink-receiving layer of the film using a JV5 printer and an ES3 ink (MIMAKI ENGINEERING CO., LTD. (Toumi-shi, Nagano, Japan)). The ink concentration was C66, M67, and Y67. The case where a uniform printed surface having high ink concentration and no spot was obtained was evaluated as A. The case where a printed surface having low ink concentration and a spot was obtained was evaluated as B. A was determined to be acceptable.

### Solvent Resistance

An appearance of the film was observed after dropping isopropanol (IPA) onto the transparent surface layer of the film and drying. The case where no mark of IPA was observed was evaluated as A. The case where the film was not dissolved but a mark of IPA was observed was evaluated as B. The case where film dissolution was observed was evaluated as C. A and B were determined to be acceptable.

### Wetting Tensile Force Test

The wettability of the film surface was evaluated using a wetting tensile force reagent in accordance with JIS K 6768:1999. The maximum value of a reagent number determined to have good wettability was recorded. The wetting tensile force of the film formed using the transparent ink-receiving layer composition (mixture of PU1 and PU2) of Example 1 was 54 mN/m or more, the wetting tensile force of the film formed using PU3 was 42 mN/m, and the wetting tensile force of the film formed using PU4 was 45 mN/m.

The details and the evaluation results of Example 1 to Example 14, Reference Example 1 to Reference Example 16, and Comparative Example 1 to Comparative Example 3 are shown in Table 2.

TABLE 2

| | | | Thickness | | | | | Thickness | |
|---|---|---|---|---|---|---|---|---|---|
| | | Thickness | of | | | | | of white | |
| | | of | transparent | | | | White | pressure- | Thickness |
| | | transparent | ink- | Crosslinking | | Thickness | pressure- | sensitive | of |
| | Transparent | surface | receiving | agent CL3 | Printed | of printed | sensitive | adhesive | decorative |
| | surface | layer | layer | (parts by | layer | layer | adhesive | layer | film |
| | layer | (μm) | (μm) | mass) | (%) | (μm) | layer | (μm) | (μm) |
| Example 1 | PU3 | 18 | 20 | — | 200 | 6 | WA1 | 65 | 109 |
| Example 2 | PU4 | 30 | 20 | — | 200 | 6 | WA1 | 65 | 121 |
| Example 3 | PU3 | 18 | 20 | — | 200 | 6 | WA3 | 40 | 84 |
| Example 4 | PU4 | 30 | 20 | — | 200 | 6 | WA3 | 40 | 96 |
| Example 5 | PU3 | 18 | 10 | — | 200 | 6 | WA1 | 65 | 99 |
| Example 6 | PU4 | 30 | 20 | — | 200 | 6 | WA2 | 30 | 86 |
| Example 7 | PU4 | 30 | 20 | — | 200 | 6 | WA1 | 30 | 86 |
| Example 8 | PU4 | 30 | 10 | — | 200 | 6 | WA2 | 30 | 76 |
| Example 9 | PU4 | 30 | 10 | — | 200 | 6 | WA1 | 30 | 76 |
| Example 10 | PU3 | 18 | 9 | 3 | 200 | 6 | WA1 | 65 | 98 |
| Example 11 | PU3 | 18 | 10 | 6 | 200 | 6 | WA1 | 65 | 99 |
| Example 12 | PU3 | 18 | 9 | — | 200 | 6 | WA1 | 65 | 98 |
| Example 13 | PU4 | 30 | 20 | — | 200 | 6 | WA3 | 40 | 96 |
| Example 14 | PU4 | 30 | 10 | — | 200 | 6 | WA1 | 65 | 111 |
| Reference | PU3 | 18 | 20 | — | — | — | WA1 | 65 | 103 |
| Example 1 | | | | | | | | | |
| Reference | PU4 | 30 | 20 | — | — | — | WA1 | 65 | 115 |
| Example 2 | | | | | | | | | |
| Reference | PU3 | 18 | 20 | — | — | — | WA3 | 40 | 78 |
| Example 3 | | | | | | | | | |
| Reference | PU4 | 30 | 20 | — | — | — | WA3 | 40 | 90 |
| Example 4 | | | | | | | | | |
| Reference | PU3 | 18 | 10 | — | — | — | WA1 | 65 | 93 |
| Example 5 | | | | | | | | | |
| Reference | PU4 | 30 | 20 | — | — | — | WA2 | 30 | 80 |
| Example 6 | | | | | | | | | |
| Reference | PU4 | 30 | 20 | — | — | — | WA1 | 30 | 80 |
| Example 7 | | | | | | | | | |
| Reference | PU4 | 30 | 10 | — | — | — | WA2 | 30 | 70 |
| Example 8 | | | | | | | | | |
| Reference | PU4 | 30 | 10 | — | — | — | WA1 | 30 | 70 |
| Example 9 | | | | | | | | | |
| Reference | PU3 | 18 | 9 | 3 | — | — | WA1 | 65 | 92 |
| Example 10 | | | | | | | | | |
| Reference | PU3 | 18 | 10 | 6 | — | — | WA1 | 65 | 93 |
| Example 11 | | | | | | | | | |
| Reference | PU3 | 18 | 9 | — | — | — | WA1 | 65 | 92 |
| Example 12 | | | | | | | | | |
| Reference | PU4 | 30 | 20 | — | — | — | WA3 | 40 | 90 |
| Example 13 | | | | | | | | | |
| Reference | PU3 | 18 | — | — | — | — | — | — | 18 |
| Example 14 | | | | | | | | | |
| Reference | PU4 | 30 | — | — | — | — | — | — | 30 |
| Example 15 | | | | | | | | | |
| Reference | PU4 | 30 | 10 | — | — | — | — | — | 40 |
| Example 16 | | | | | | | | | |
| Comparative | PU1/PU2 | 18 | 20 | — | 200 | 6 | WA1 | 30 | 84 |
| Example 1 | | | | | | | | | |
| Comparative | Acrylic | 30 | — | — | 200 | 6 | WA1 | 30 | 66 |
| Example 2 | | | | | | | | | |
| Comparative | PU1/PU2 | 30 | — | — | 200 | 6 | WA1 | 30 | 66 |
| Example 3 | | | | | | | | | |

| | Tensile | | | | | | | |
|---|---|---|---|---|---|---|---|---|
| | strength | | | | | | | |
| | at 2% | Yield | | Adhesive | | | | |
| | strain | strength | | force 1 | Weather | Weather | Inkjet | |
| | (N/25 | (N/25 | Elongation | (N/25 | resistance | resistance | printing | Solvent |
| | mm) | mm) | (%) | mm) | 1 | 2 | property | resistance |
| Example 1 | 12 | 22 | 136 | 15 | ND | ND | A | A |
| Example 2 | 8 | 16 | 280 | 16 | ND | ND | A | B |
| Example 3 | 8 | 16 | 214 | 17 | ND | ND | A | A |
| Example 4 | 8 | 17 | 126 | 16 | ND | ND | A | B |
| Example 5 | 12 | 22 | 199 | 26 | ND | ND | A | A |
| Example 6 | ND | ND | ND | ND | A | A | A | B |
| Example 7 | ND | ND | ND | ND | A | A | A | B |
| Example 8 | ND | ND | ND | ND | A | A | A | B |
| Example 9 | ND | ND | ND | ND | A | A | A | B |
| Example 10 | ND | ND | ND | 20 | A | A | A | A |
| Example 11 | ND | ND | ND | 19 | A | A | A | A |
| Example 12 | ND | ND | ND | 18 | A | A | A | A |
| Example 13 | ND | ND | ND | ND | A | A | A | B |
| Example 14 | 8 | 15 | 195 | 17 | ND | ND | A | B |
| Reference | 13 | 24 | 53 | 15 | ND | ND | ND | A |
| Example I | | | | | | | | |
| Reference | 8 | 16 | 90 | 16 | ND | ND | ND | B |
| Example 2 | | | | | | | | |
| Reference | 14 | 27 | 68 | 26 | ND | ND | ND | A |
| Example 3 | | | | | | | | |
| Reference | 13 | 24 | 51 | 15 | ND | ND | ND | B |
| Example 4 | | | | | | | | |
| Reference | 13 | 26 | 156 | 15 | ND | ND | ND | A |
| Example 5 | | | | | | | | |
| Reference | ND | ND | ND | ND | A | A | ND | B |
| Example 6 | | | | | | | | |
| Reference | ND | ND | ND | ND | A | A | ND | B |
| Example 7 | | | | | | | | |
| Reference | ND | ND | ND | ND | A | A | ND | B |
| Example 8 | | | | | | | | |
| Reference | ND | ND | ND | ND | A | A | ND | B |
| Example 9 | | | | | | | | |
| Reference | 12 | 27 | 71 | 19 | A | A | ND | A |
| Example 10 | | | | | | | | |
| Reference | 12 | 28 | 65 | 19 | A | A | ND | A |
| Example 11 | | | | | | | | |
| Reference | 12 | 27 | 80 | 18 | A | A | ND | A |
| Example 12 | | | | | | | | |
| Reference | ND | ND | ND | ND | A | A | ND | B |
| Example 13 | | | | | | | | |
| Reference | 14 | 27 | 16 | ND | ND | ND | ND | ND |
| Example 14 | | | | | | | | |
| Reference | 7 | 15 | 110 | ND | ND | ND | ND | ND |
| Example 15 | | | | | | | | |
| Reference | 7 | 15 | 168 | ND | ND | ND | ND | ND |
| Example 16 | | | | | | | | |
| Comparative | ND | ND | ND | ND | ND | ND | B | C |
| Example 1 | | | | | | | | |
| Comparative | ND | ND | ND | ND | ND | ND | B | C |
| Example 2 | | | | | | | | |
| Comparative | ND | ND | ND | ND | ND | ND | A | C |
| Example 3 | | | | | | | | |

### Example 15

Polyurethane 1 (PU1) and polyurethane 5 (PU5) were mixed using a mixer (TK Auto Homo Mixer, PRIMIX Corporation (Awaji-shi, Hyogo, Japan)) to prepare a transparent ink-receiving layer composition. The mass ratio of PU1 and PU5 was 100:10 in terms of solid content. The solid content of the transparent ink-receiving layer composition was about 30 mass %.

Polyurethane 3 (PU3) was applied onto a polyester film (support film) having a thickness of 50 μm using a knife coater, and dried at 95° C. for 5 minutes to form a transparent surface layer having a thickness of 18 μm.

The transparent ink-receiving layer composition was applied onto a polyester film having a thickness of 50 μm using a knife coater, and dried at 95° C. for 5 minutes to form a transparent ink-receiving layer having a thickness of 20 μm.

Tacky adhesive polymer 4 (ADH4) and the crosslinking agent 1 (CL1) were mixed to prepare a transparent pressure-sensitive adhesive. The mass ratio of ADH4 and CL1 was 100:0.2 in terms of solid content.

A transparent pressure-sensitive adhesive was applied onto a silicone-coated polyethylene laminate paper liner using a knife coater, and dried at 95° C. for 5 minutes to form a transparent pressure-sensitive adhesive layer having a thickness of 10 μm.

The transparent pressure-sensitive adhesive layer was laminated on the transparent ink-receiving layer. The polyester film on the transparent ink-receiving layer was removed. The silicone-coated polyethylene laminate paper liner on the transparent pressure-sensitive adhesive layer was removed. The transparent surface layer was laminated on the exposed transparent pressure-sensitive adhesive layer. In this manner, an ink-receiving film having the support film/transparent surface layer/transparent pressure-sensitive adhesive layer/transparent ink-receiving layer laminated in this order was produced.

A premix including white pigment 1 (WP1), dispersant 1 (D1), and methyl ethyl ketone (MEK) was prepared. The mass ratio of WP1 and D1 was 5:1 in terms of solid content. The solid content of the premix was about 66 mass %.

The premix and the tacky adhesive polymer 1 (ADH1) were mixed. The mass ratio of ADH1, white pigment 1, and D1 was 100:50:10 in terms of solid content. Crosslinking agent 4 (CL4) was mixed to the obtained mixture to prepare a white pressure-sensitive adhesive 4 (WA4). The mass ratio of ADH1 and CL4 was 100:0.2 in terms of solid content. The solid content of WA4 was about 55 mass %.

WA4 was applied onto a silicone-coated polyethylene laminate paper liner using a knife coater, and dried at 95° C. for 5 minutes to form a white pressure-sensitive adhesive layer having a thickness of 65 μm. In this manner, a pressure-sensitive adhesive film including the white pressure-sensitive adhesive layer and the release liner was produced.

A printed layer having a thickness of 6 μm was formed on the transparent ink-receiving layer of the ink-receiving film by inkjet printing using a JV5 printer and an ES3 ink (MIMAKI ENGINEERING CO., LTD. (Toumi-shi, Nagano, Japan)). The ink concentration was C66, M67, and Y67. The white pressure-sensitive adhesive layer was laminated on the printed layer, and the support film was removed to produce the decorative film of Example 15.

### Reference Example 17

A laminate film of Reference Example 17 was produced in the same procedure as in Example 15 except that no printed layer was provided. Reference Example 17 has the same layer configuration as that of Example 15 except that there is no printed layer, and was prepared for the purpose of examining an effect on characteristics of the decorative film such as a tensile strength at 5% strain or embossability by presence or absence of the printed layer.

### Tensile Strength at 5% Strain

A test piece was prepared by cutting a film into a width of 25 mm and a length of 150 mm. Using a tensile tester (Tensilon universal testing machine, model: RTC-1210A, manufactured by A&D Company, Limited (Toshima-ku, Tokyo, Japan)), the tensile strength at 5% strain at 20° C. was measured under the condition at 20° C., the distance between grips of 100 mm, at the tensile speed of 300 mm/min.

### Embossability

A test piece was prepared by bonding the film to an aluminum plate having a thickness of 1 mm at room temperature. An embossing machine (AMADA CO., LTD. (Isehara-shi, Kanagawa, Japan)) was used to perform embossing processing of Chinese characters and numeric characters on the test piece. The embossing pressure was about 15 MPa. The embossing depth was approximately 1.25 mm. The test piece was cut and the cross section was observed using an optical microscope. The case where film floating was not observed was evaluated as good, and the case where film floating was observed was evaluated as not good.

### Impact Resistance

The impact resistance was evaluated in accordance with JIS K 5600 May 3:1999 (ASTM D 2794). Specifically, an impact shaft was dropped on the film surface using an IM-201 DuPont (trade name) impact tester (TESTER SANGYO CO., LTD. (Iruma-shi, Saitama, Japan)) under the condition of the weight of 500 gf, the height of 500 mm, the tip diameter of the impact shaft of 6.3 mm, and the temperature of 20° C. The appearance of the film after the test was visually observed, and the case where cracking of the film was not observed was evaluated as good, and the case where cracking of the film was observed was evaluated as not good.

### Adhesive Force 2

A test piece was prepared by cutting a film into a width of 25 mm and a length of 150 mm. The test piece was adhered onto an A5052P aluminum panel (PALTEK CORPORATION (Hiratsuka-shi, Kanagawa, Japan)) at 23° C. using a roller. The adhering method was in accordance with JIS Z 0237:2009. The test piece was left at 20° C. for 48 hours. Using a tensile tester (Tensilon universal testing machine, model: RTC-1210A, manufactured by A&D Company, Limited (Toshima-ku, Tokyo, Japan)), the adhesive force at the time of performing 180 degree peeling was measured at a peeling rate of 300 mm/min at 20° C.

The details and evaluation results of Example 15 and Reference Example 17 are shown in Table 3.

TABLE 3

| | | | Thickness | | | | | | | | |
|---|---|---|---|---|---|---|---|---|---|---|---|
| | | | of | Thickness | | Thickness | | | | | |
| | | Thickness | transparent | of | | of white | | Tensile | | | |
| | | of | pressure- | transparent | | pressure- | Thickness | strength | | | |
| | | transparent | sensitive | ink- | Thickness | sensitive | of | at 5% | | | Adhesive |
| | Transparent | surface | adhesive | receiving | of printed | adhesive | decorative | strain | | | force 2 |
| | surface | layer | layer | layer | layer | layer | film | (N/25 | Emboss- | | (N/25 |
| | layer | (μm) | (μm) | (μm) | (μm) | (μm) | (μm) | mm) | ability | Impact | mm) |
| Example | PU3 | 18 | 10 | 20 | 6 | 65 | 119 | 21 | Good | Good | 15 |
| 15 | | | | | | | | | | | |
| Reference | PU3 | 18 | 10 | 20 | 0 | 65 | 113 | 26 | Good | Good | 16 |
| Example | | | | | | | | | | | |
| 17 | | | | | | | | | | | |

Various variations of the above-mentioned embodiments and examples will be apparent to those skilled in the art without departing from the basic principle of the present invention. In addition, it is apparent for a person skilled in the art that various modifications and variations of the present invention can be made without departing from the spirit and scope of the present invention.

### REFERENCE SIGNS LIST

10 Decorative film
11 Transparent surface layer
12 Transparent ink-receiving layer
13 Transparent pressure-sensitive adhesive layer
14 Printed layer
16 Pressure-sensitive adhesive layer
18 Release liner
20 Ink-receiving film
22 Support film
30 Pressure-sensitive adhesive film

1. A decorative film comprising: a transparent surface layer including polycarbonate-based polyurethane; a transparent ink-receiving layer including polyether-based polyurethane; a printed layer disposed on the transparent ink-receiving layer; and a pressure-sensitive adhesive layer in this order.

2. The decorative film according to claim 1, wherein the polyether-based polyurethane of the transparent ink-receiving layer is water-based polyether-based polyurethane.

3. The decorative film according to claim 1, wherein the polycarbonate-based polyurethane of the transparent surface layer has an alicyclic structure.

4. The decorative film according to claim 1, wherein the printed layer is an inkjet printed layer.

5. The decorative film according to claim 1, wherein the pressure-sensitive adhesive layer contains a white colorant.

6. The decorative film according to claim 1, wherein the pressure-sensitive adhesive layer is an acrylic pressure-sensitive adhesive layer.

7. The decorative film according to claim 1, further comprising a transparent pressure-sensitive adhesive layer between the transparent surface layer and the transparent ink-receiving layer.

8. An ink-receiving film comprising: a support film; a transparent surface layer including polycarbonate-based polyurethane, and a transparent ink-receiving layer including polyether-based polyurethane in this order.

9. The ink-receiving film according to claim 8, wherein the polyether-based polyurethane of the transparent ink-receiving layer is water-based polyether-based polyurethane.

10. The ink-receiving film according to claim 8, wherein the polycarbonate-based polyurethane of the transparent surface layer has an alicyclic structure.

11. A method for producing a decorative film, the method comprising:
preparing an ink-receiving film including a support film, a transparent surface layer including polycarbonate-based polyurethane, and a transparent ink-receiving layer including polyether-based polyurethane in this order;
preparing a pressure-sensitive adhesive film including a pressure-sensitive adhesive layer and a release liner;
printing an ink on the transparent ink-receiving layer to form a printed layer;
laminating the ink-receiving film and the pressure-sensitive adhesive film to bring the printed layer and the pressure-sensitive adhesive layer into contact with each other; and
removing the support film to form a decorative film.

12. The method according to claim 11, wherein the polyether-based polyurethane of the transparent ink-receiving layer is water-based polyether-based polyurethane.

13. The method according to claim 12, wherein the ink is a solvent-based ink.

14. The method according to claim 11, wherein the polycarbonate-based polyurethane of the transparent surface layer has an alicyclic structure.

15. A decorative film kit comprising:
an ink-receiving film including a support film, a transparent surface layer including polycarbonate-based polyurethane, and a transparent ink-receiving layer including polyether-based polyurethane in this order; and
a pressure-sensitive adhesive film including a pressure-sensitive adhesive layer and a release liner.

16. The decorative film kit according to claim 15, wherein the polyether-based polyurethane of the transparent ink-receiving layer is a water-based polyether-based polyurethane.

17. The decorative film kit according to claim 15, wherein the polycarbonate-based polyurethane of the transparent surface layer has an alicyclic structure.
